(19) United States
(12) Patent Application Publication
(10) Pub. No.: US 2022/0091605 A1
(43) Pub. Date: Mar. 24, 2022

(54) UNMANNED VEHICLE AND UNMANNED VEHICLE RESCUE SYSTEM

(71) Applicant: Move-X Autonomous Driving Technology Co., Ltd., Lu'an (CN)

(72) Inventors: Guoliang ZHAO, Lu'an (CN); Hui LI, Lu'an (CN)

(73) Assignee: Move-X Autonomous Driving Technology Co., Ltd., Lu'an (CN)

(21) Appl. No.: 17/467,463

(22) Filed: Sep. 7, 2021

(30) Foreign Application Priority Data
Sep. 22, 2020 (CN) 202010998523.5

(51) Int. Cl. G05D 1/00; G08B 21/04; G08B 25/10; G08B 25/01

(52) U.S. Cl. CPC G05D 1/0022; G08B 21/04; A61G 3/00; G08B 25/016; G08B 25/10

(57) ABSTRACT

The present disclosure provides an unmanned vehicle and an unmanned rescue system. The unmanned vehicle includes: a communication unit for receiving a rescue request signal carrying personal information and location information of a rescue object; a main control unit for, after the communication unit receives the rescue request signal, controlling the unmanned vehicle to drive to the location of the rescue object; a broadcasting unit controlled by the main control unit for broadcasting the personal information and location information of the rescue object during the drive of the unmanned vehicle. The unmanned vehicle rescue system includes a triggering device, a control center and the unmanned vehicle; the triggering device is used for sending out a “help” signal; the control center is used for sending out a rescue request signal to the unmanned vehicle.

### RELATED APPLICATIONS

This application claims the benefit of priority to Chinese Patent Application No. 202010998523.5, filed on Sep. 22, 2020, and the entire contents of which are incorporated herein by reference.

### TECHNICAL FIELD

The present disclosure relates to the technical field rescue technologies, particularly relates to an unmanned vehicle and an unmanned vehicle rescue system.

### BACKGROUND

China has a huge population; the problem of ageing population is increasingly prominent. More and more elderly people are often left home alone or cannot be taken care of, since their children are out for work, and so on. The elderly needs someone to be around for timely help in case they suffer a sudden disease, or an accident or other unexpected situations occur. With the spread of smart community, community management tends to be more humane, needs to be more considerate and thoughtful. Consequently, it is necessary to address the above-mentioned problems.

Currently, in the case where an elderly suffers a disease or has an accident at home, one of the following may occur:

1. Call the police or ambulance crew (or press an emergency alarm device at home to call the police for help), which requires a police car or an ambulance arriving at the scene. In this case, the waiting time may be relatively long, and help and rescue may not be delivered in time.

2. Ask community management personnel (for example, property management personnel, or members of the community management) for help through an alarm device at home. In this case, high requirements are imposed on the personnel, they need to be on duty 24 hours a day; otherwise may result in failing to response to a request for help. Thus, this is not effective.

3. The accident may be detected by a surveillance camera installed at home, and artificial intelligence (Al) algorithm may process the detected information in the background. In this case, a number of cameras need to be installed at home, which may have high costs. In addition, such real-time monitoring may result in personal privacy leakage, and high security risks.

### SUMMARY

The present disclosure is to solve the technical problem of how to quickly and effectively help the elderly or other vulnerable population who are alone and in urgent need of help, so that they can be helped and rescued timely.

In order to solve the above-mentioned technical problem, In one aspect, the present disclosure provides an unmanned vehicle, including: a communication unit to receive a rescue request signal including personal information and location information of a rescue object; a main control unit to control the unmanned vehicle to drive to a location of the rescue object; and a broadcasting unit to broadcast the personal information and location information of the rescue object during driving to the location of the rescue object, where the main control unit controls the communication unit and the broadcasting unit.

In another aspect, the present disclosure provides an unmanned vehicle rescue system, including: a triggering device to send a “help” signal when a rescue object needs to be rescued; an unmanned vehicle; and a control center to receive the “help” signal and send the “help” signal to the unmanned vehicle, where the unmanned vehicle includes: a communication unit to receive a rescue request signal including personal information and location information of a rescue object; a main control unit to control the unmanned vehicle to drive to a location of the rescue object; and a broadcasting unit to broadcast the personal information and location information of the rescue object during driving to the location of the rescue object, where the main control unit controls the communication unit and the broadcasting unit.

In yet another aspect, the present disclosure provides a method for rescuing, including: receiving, by a communication unit of an unmanned vehicle, a rescue request signal including personal information and location information of a rescue object; controlling, by a main control unit of the unmanned vehicle, the unmanned vehicle to drive to a location of the rescue object; and broadcasting, by a broadcasting unit of the unmanned vehicle, the personal information and location information of the rescue object during driving to the location of the rescue object.

Compared with the existing technologies, the technical solutions of the present disclosure at least have the advantageous effects below:

The control center receives a distress signal of the triggering device, sends a rescue request signal to the unmanned vehicle. The unmanned vehicle drives towards the rescue object after receiving the rescue request signal, simultaneously, propagates information of the rescue object to prompt the passers-by to help. As such, the object in urgent need of help can quickly and effectively receive rescue.

Compared with other solutions of the same type that require to wait for the police car or ambulance to arrive at the scene, particularly, in traffic congestion, the police car or ambulance need to take a long time to arrive at the scene, easily miss the timing for instant rescue, the present solution notifies the nearest unmanned vehicle to quickly arrive at the first scene using a control center, prompts the passers-by to help, solves the problem that the person to be rescued cannot receive timely rescue on the first scene after the occurrence of emergency conditions, avoids the long waiting time for rescue, buys the precious time for saving the life and property of people and reduces the losses to the lowest.

For certain requests for help, they can be handled with the help from residences in the same community using the nearest unmanned vehicle, without calling the police or medical personnel, which can lessen the burden on police/medical resources.

By replacing caretaker with unmanned vehicle in the community, there is no need of installing a large number of surveillance cameras at home, only a handy button or APP installed on a tablet computer are required. On the one hand, user's costs are reduced; on the other hand, users are given extremely large amount of privacy.

The sound-light alarm and text-graphic display on the unmanned vehicle are used to prompt passers-by to help. Further, compared with other solutions of the same type that the alarm device and the image display are install at home or inside the car for the purposes of communication between the person asking for help and the paramedics instead of interaction with passers-by, the graphic-text display on the unmanned vehicle of the present solution can interact with passers-by, awards the kind-hearted passers-by who successfully delivered help, which is conducive to building a united loving and beautiful harmonious society

The solution of the present disclosure is not only suitable for rescue objects of the elderly who are at home alone, but also general public of different sex and age who need rescuing, and the suitable locations of the rescue objects that are not only the community but also other places such as scenic spots, industrial parks, schools, country yards, roads and streets, etc. Consequently, the solution of the present disclosure has broad application.

### BRIEF DESCRIPTION OF THE DRAWINGS

In order to describe the technical solutions in some exemplary embodiments of the present disclosure, the accompanying drawings for the descriptions will be briefly introduced below. Apparently, the accompanying drawings described below are only some exemplary embodiments of the present disclosure. For one of ordinary skill in the art, other accompanying drawings may be further obtained based on these accompanying drawings without inventive skills.

FIG. 1 is a schematic diagram of a structure of an unmanned vehicle rescue system according to some exemplary embodiments of the present disclosure;

FIG. 2 to FIG. 4 are schematic diagrams of display examples of a display device of an unmanned vehicle rescue system according to some exemplary embodiments of the present disclosure;

FIG. 5 is a schematic diagram of a structure of application examples of an unmanned vehicle rescue system according to some exemplary embodiments of the present disclosure; and

FIG. 6 is a schematic diagram of a flowchart of an application example of an unmanned vehicle rescue system according to some exemplary embodiments of the present disclosure.

### DETAILED DESCRIPTION

The technical solutions in some exemplary embodiments of the present disclosure will be described below with reference to the accompanying drawings. Apparently, the described embodiments are merely a part of the embodiments of the present disclosure rather than all of embodiments. On the basis of some exemplary embodiments of the present disclosure, all of the other embodiments obtained by one of ordinary skill in the art without creative efforts are also within the scope of protection of the present disclosure.

Along with the advancements of technologies, unmanned vehicle (also referred to as self-driving, automatic driving, autonomous driving in various situations) cars ( ) technologies tend to mature; unmanned vehicles are used in a wide variety of application scenarios in daily life. The solutions of the present disclosure adopt the technologies of unmanned vehicles, employ unmanned vehicles to prompt people nearby to provide on-site help, thereby solving the problem of providing timely assistance on-site after an accident occurs, avoiding a long period of time for rescue, saving time to save life and/or reduce losses. The solutions of the present disclosure will be described in detail below with reference to some exemplary embodiments and accompanying drawings.

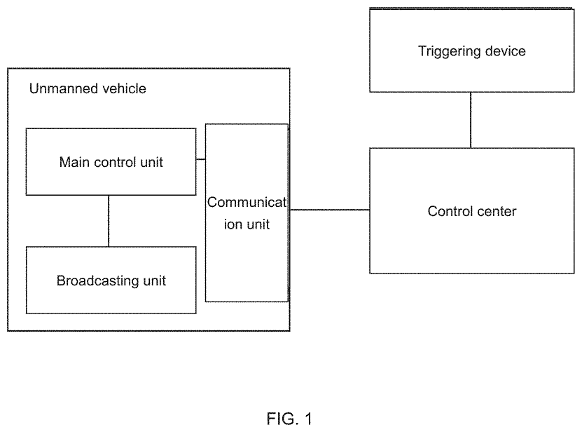

With reference to FIG. 1, an unmanned vehicle rescue system according to some exemplary embodiments may include: a triggering device, a control center, and an unmanned vehicle; the triggering device is used for sending a signal for help (hereinafter “‘help’ signal” when a person needs help; the control center is used for, after receiving the “help” signal, sending out a rescue request signal to the unmanned vehicle; the rescue request signal carries personal information and location information of the person who needs help; the unmanned vehicle is used for, after receiving the rescue request signal, autonomously driving to a location of the person who needs help, meanwhile broadcasting the personal information and the location information of the person the autonomous driving towards the location of the person who needs help.

The triggering device may include a portable electronic device and/or a physical or touch help button that can be touched by a rescue object; the portable electronic device may be installed with a rescue system application (APP), or may be provided with a single-press-to-call-for-help button.

Specifically, the triggering device may be a portable electronic device that may be easily carried, such as a mobile phone, a tablet computer, etc., and the mobile phone or tablet computer may be installed with a rescue system application. When a person (a rescue object) suffers a sudden disease or has an accident, the person may access the rescue system APP, click on a rescue button on an interface thereof to trigger a “help” signal. Considering the cases where some seniors may not be able to quickly access the APP in such situations, the single-press-to-call-for-help button may be directly disposed on a mobile phone or tablet computer, which may be, for example, a physical button or a touch button on a screen. Alternatively, the triggering device may be a physical button or a touch help button that can be touched by the rescue object. The help button may be disposed on an alarm device at home, or, may be installed on the clothes or belongs of the rescue object so that the “help” signal can be triggered timely.

The rescue system APP or alarm device may instantly send the “help” signal to the control center (that is, the background service center of the rescue system) after the “help” signal is triggered. The control center may be used for receiving, sending, storing and processing information. In some exemplary embodiments, the control center may be used for sending a rescue request signal to the unmanned vehicle after receiving the “help” signal. The rescue request signal carries personal information and location information of the rescue object.

For instance, the “help” signal sent by the rescue system APP may carry pre-stored personal basis information and location information of the rescue object, such a name, gender, age, address, etc. The control center may perform information extraction and processing after receiving the “help” signal, then generate a rescue request signal; then the control center may send the rescue request signal to an unmanned vehicle nearest to the rescue object based on the location information of the rescue object. The control center may also obtain the location information of the rescue object based on a positioning system in the portable device or alarm device, obtain the pre-stored basic personal information of the rescue object from a database of the control center based on the location information, and then generate a rescue request signal; next the control center may send the rescue request signal to the unmanned vehicle nearest to the rescue object based on the location information of the rescue object.

With further reference to FIG. 1, in some exemplary embodiments, the unmanned vehicle may include: a communication unit, a main control unit and a broadcasting unit. It is noted that the unit herein may be a hardware assembly, that is, a device or more than one device designed to perform at least one function.

The communication unit may be used for receiving a rescue request signal, where the rescue request signal carries personal information and location information of the rescue object. Specifically, the communication unit may have the function of remotely receiving/sending information related to rescue, etc. For example, the communication unit may be an onboard remote information processor (Telematics BOX, or T-BOX), a 4G/5G/6G communication module, or the like.

The main control unit may be used for, after the communication unit receives the rescue request signal, controlling the unmanned vehicle to drive to the location of the rescue object.

Specifically, the unmanned vehicle may be a vehicle that is capable of autonomously driving to a specified location. It may be provided with a variety of sensors. The main control unit may be a central processing unit of the unmanned vehicle and a core unit that performs: receiving/transmitting information with other control units/modules onboard, storing and processing information, controlling and decision making, etc. The main control unit may perform controlling and decision making based on information sensed by the variety of sensors to achieve safe driving. For instance, when a pedestrian or an obstacle is sensed, the driving speed of the unmanned vehicle may be reduced.

The broadcasting unit, controlled by the main control unit, may be used for broadcasting the personal information and location information of the rescue object during the drive of the unmanned vehicle.

Information broadcasting may be at least one of audio broadcasting or visual broadcasting. Specifically, the broadcasting unit may include an audio broadcasting device and/or a display device; the audio broadcasting device may be used for broadcasting personal information and location information of the rescue object, the display device may be used for visually displaying personal information and location information of the rescue object.

In some exemplary embodiments, the broadcasting unit may include an audio broadcasting device installed on the unmanned vehicle. The audio broadcasting device onboard may be turned on during the drive to perform audio broadcasting of the information of the rescue object, e.g., Room xxx, building xx, Mr./Mrs. xxx needs onsite emergency rescue. Further, the broadcasting unit may further include an alarm light that may be constantly on or flashing during the drive. The audio broadcasting device and the alarm light may form a sound-light alarm device on the unmanned vehicle to prompt community management personnel or passers-by to perform onsite rescue through sound-light alarm, i.e., audio broadcasting the information of the rescue object plus flashing light.

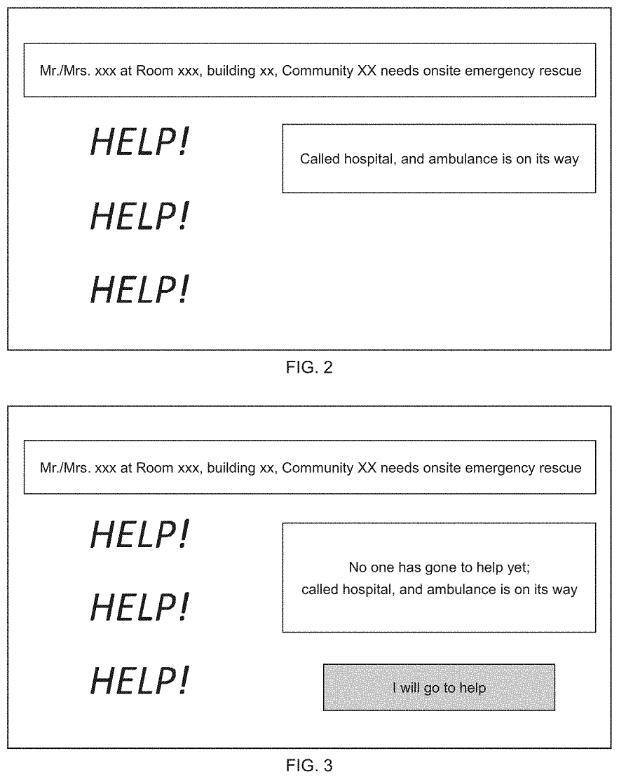

The broadcasting unit may further include a display device. The display device may include a display screen or display film integrated in the unmanned vehicle for graphic-text displaying information of the rescue object (location information, rescue information, etc.) so as to prompt community management personnel or passers-by to offer rescue. FIG. 2 provides a display example.

Further, the main control unit is further used for receiving a rescue response signal and obtaining information of a rescue volunteer; the rescue response signal may be triggered when the rescue volunteer presses a rescue response button disposed on the unmanned vehicle, or may be triggered when a rescue volunteer touches a rescue response touch key displayed by the display device, or may be triggered when the rescue volunteer scans a rescue response QR code displayed by the display device with a mobile electronic device.

In some exemplary embodiments, the rescue response button may be disposed on the unmanned vehicle. The rescue response button may be a physical button or a touch button (a virtual button displayed on a touch screen). When a rescuer volunteer near the unmanned vehicle is willing to perform the onsite rescue, the rescue volunteer may press the rescue response button to trigger a rescue response signal. The main control unit may control the display device to display the rescue response touch button. In the display example illustrated by FIG. 3, when the rescue volunteer touches the rescue response touch button “I would like to quickly go to rescue”, the rescue response signal is triggered.

The main control unit, after receiving the rescue response signal, may control a photographing device on the unmanned vehicle to obtain a picture of the rescue volunteer when the rescue volunteer triggers the rescue response signal; information of the rescue volunteer includes image information of the rescue volunteer. Normally, the photographing device is installed near the rescue response button/display device to ensure capturing valid image information. The main control unit sends the image information of the rescue volunteer to the control center through the communication unit. The control center compares the personnel information in the database with the image information to obtain information of the rescue volunteer (including name and mobile phone number, etc.) and feeds the information back to the unmanned vehicle.

In some exemplary embodiments, when the rescue volunteer triggers the rescue response signal, the main control unit may further control the display device to display a dialog box requesting the rescue volunteer to enter mobile phone number, and perform real-name authentication or information confirmation with the rescue volunteer based on the mobile phone number entered by the rescue volunteer. In this way, the image of the rescue volunteer may also be obtained without a photographing device.

The main control unit may send a mobile phone number of the rescue object and/or a relative or friend of the rescue object to a mobile phone of the rescue volunteer through the communication unit. In some exemplary embodiments, the control center may send a mobile phone number of the rescue object and/or a relative or friend of the rescue object to a mobile phone of the rescue volunteer.

In some exemplary embodiments, the main control unit may further control the display device to display a rescue response QR code. After the rescue volunteer scans the rescue response QR code using a mobile electronic device (e.g., a mobile phone), the mobile electronic device displays an information input and confirmation interface. The rescue volunteer then enters personal information (e.g. name, mobile phone number, etc.) through the information input and confirmation interface and confirms to go to rescue, thereby triggering a rescue response signal.

Obtaining information of the rescue volunteer may, on the one hand, may ensure the safety and effectiveness of the rescue and allow the rescue volunteer to timely contact the rescue object or a relative or friend of the rescue object, on the other hand, may allow offering subsequent publicity, praise or awards to the rescue volunteer.

Some exemplary embodiments provide rescue response that may deliver rescue more effectively without wasting human labor. The main control unit, after receiving the rescue response signal, may turn off the audio broadcasting device; or control the display device to display information that a rescue volunteer has gone to rescue, as in the display example illustrated by FIG. 4. As such, other passers-by may decide whether it is still necessary to go to rescue according to actual conditions, this may avoid the situation where a crowd gathering at the site for rescue.

In some exemplary embodiments, the information of the rescue volunteer may include location information of the rescue volunteer. The display device may be used for displaying a navigation route from the location of the rescue volunteer to the rescue object. Reference may be made to the display example illustrated by FIG. 4. The real-time location information of the rescue volunteer may be obtained according to the real-time location of the unmanned vehicle, or may be obtained according to the real-time location of the mobile phone of the rescue volunteer. The navigation route may be provided by the control center or the main control unit of the unmanned vehicle so as to help the rescue volunteer to quickly arrive at the site of rescue.

The unmanned vehicle rescue system may further include a terminal receiving device disposed on a rescue office (not shown in FIG. 1); the main control unit may be further used for sending the rescue request signal to the terminal receiving device through the communication unit; or the control center may be further used for sending the rescue request signal to the terminal receiving device. The rescue office may be a police station, a hospital, a security office of property management, etc. In the display examples illustrated in FIG. 3 and FIG. 4, the unmanned vehicle may not only perform human-computer interaction with passers-by, but also can display the rescue progress, such as information of a police car, an ambulance, or property management personnel on their way to the rescue site.

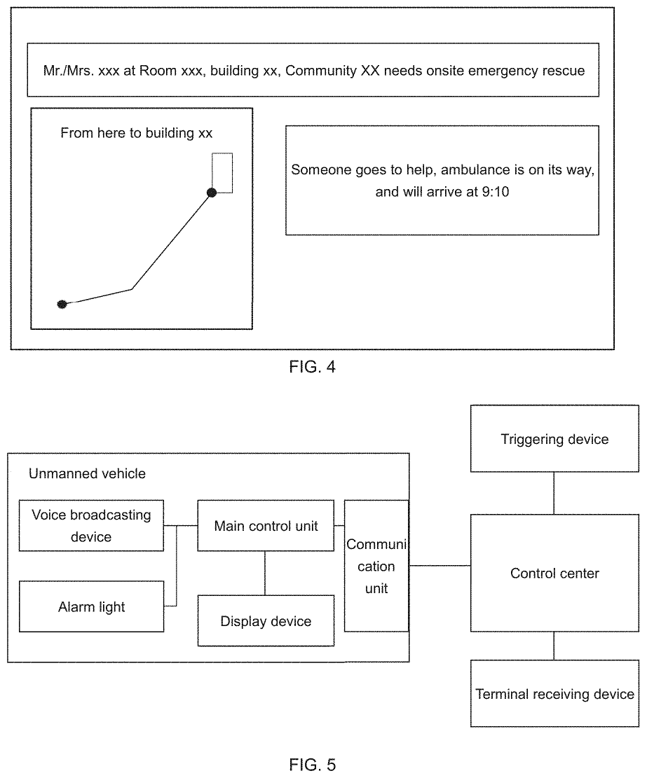

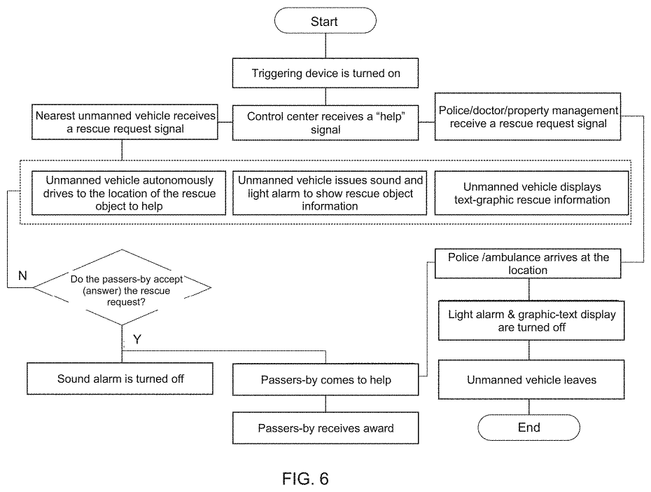

A specific implementation process will be described below with reference to the structure and flowchart of the unmanned vehicle rescue system illustrated in FIG. 5 and FIG. 6. An accident occurs, a person who needs emergency help (a rescue object) accesses a mobile phone APP and clicks a rescue button shown on the interface or press a physical rescue button installed at home. The triggering device is turned on to trigger a “help” signal; the control center receives the “help” signal, generates a rescue request signal that includes information of the rescue object (name, gender, age, address, etc.). The control center instantly forwards the rescue request signal to a near-by police station or hospital, as well as the property management of the community, and meanwhile forwards the rescue request signal to an unmanned vehicle in a community of the location, or an unmanned vehicle nearest to the community. The unmanned vehicle, after receiving the rescue request signal, immediately autonomously drives to the location of the rescue object. The alarm device on the unmanned vehicle is turned on during driving, the alarm light flashes and the audio broadcasting device broadcasts the information of the rescue object (e.g. Room xxx, building xx, Mr./Mrs. xxx needs door-to-door emergency rescue). The display device on the unmanned vehicle controls the display screen to show graphic-text information of the rescue object, so as to prompt people in that community to offer help and rescue. The display screen of the unmanned vehicle may further display the process of a police car, an ambulance, or property management personnel coming to the rescue site. After the police car or ambulance arrive at the scene, the light alarm and graphic-text display on the unmanned vehicle are turned off. After the rescue object is successfully rescued, the rescue personnel may turn off the help triggering device via an APP or a button.

During the process of the unmanned vehicle driving to the location of the rescue object, passers-by nearby may interact with the unmanned vehicle based on the information of the rescue object displayed on the unmanned vehicle, receive or response to the request by scanning a QR code on the display screen or by pressing a button on the vehicle. After a rescue person completes this response operation, the sound alarm of the unmanned vehicle is turned off, yet the light alarm is still on; meanwhile, the rescue person receives the mobile phone number of the rescue object sent by the control center, and then accesses to the site to offer help: including ringing a doorbell, dialing the mobile phone number for security confirmation. Later on, after medical professionals arrive at the site, and send the rescue object to the hospital, this rescue person will be awarded (monetary rewards, or credit scores, etc.). This rescue method has low costs, it allows a rescue object to receive help and rescue quickly before the police or medical professional arrive at the location. In addition, it may promote good deeds, and mutual help.

In some exemplary embodiments of the present disclosure, by using an unmanned vehicle that operates and delivers services in a community or around a community, a person to be rescued may send a “help” signal via a mobile phone APP or a home alarm device. The unmanned vehicle, after receiving the “help” signal, autonomously drives to the location of the person to be rescued, displays the information of the person to be rescued with image and light-sound alarms through the display device and the alarm device on the unmanned vehicle to prompt people (such as property management personnel or passing residents in the community to go to the location to offer help and rescue. While the unmanned vehicle receives a rescue request signal, the control center or the unmanned vehicle forwards the information of the person to be rescued (location, etc.) to the nearest police station or hospital. In this way, the person to be rescued may get quick help and rescue from the property management or residents in the community before the arrival of police or medical staff.

In summary, after reviewing the detailed contents of this disclosure, a person skilled in the art would appreciate that the above-mentioned detailed contents of the disclosure are illustrative, not restrictive. In addition, it should be appreciated by a person skilled in the art that the present disclosure intends to include various changes, improvements and modifications to the disclosed exemplary embodiments. These changes, improvements and modifications are intended to be proposed in the present disclosure and within the scope of the embodiments of the present disclosure.

What is claimed is:

1. An unmanned vehicle, comprising:
a communication unit to receive a rescue request signal including personal information and location information of a rescue object;
a main control unit to control the unmanned vehicle to drive to a location of the rescue object; and
a broadcasting unit to broadcast the personal information and location information of the rescue object during driving to the location of the rescue object, wherein,
the main control unit controls the communication unit and the broadcasting unit.

2. The unmanned vehicle according to claim 1, wherein
the broadcasting unit includes at least one of an audio broadcasting device, or a display device;
the audio broadcasting device is configured to broadcast the personal information and the location information of the rescue object; and
the display device is configured to display the personal information and the location information of the rescue object.

3. The unmanned vehicle according to claim 2, wherein,
the main control unit is further configured to receive a rescue response signal and obtain information of a rescue offeror;
the rescue response signal is triggered by at least one of:
the rescue offeror pressing an rescue response button disposed on the unmanned vehicle,
the rescue offeror touching a button displayed on the display device, or
the rescue offeror scanning a rescue response QR code displayed on the display device using a mobile electronic device.

4. The unmanned vehicle according to claim 3, wherein,
the information of the rescue offeror includes location information of the rescue offeror; and
the display device is further configured to display a navigation route from a location of the rescue offeror to the rescue object.

5. The unmanned vehicle according to claim 3, further comprising:
a photographing device to capture an image of the rescue offeror when the rescue response signal is triggered,
wherein the information of the rescue offeror further includes image information of the rescue offeror.

6. The unmanned vehicle according to claim 3, wherein,
the information of the rescue volunteer includes a mobile phone number of the rescue offeror; and
the main control unit is further configured to send at least one of a mobile phone number of the rescue object, a mobile phone number of a relative of the rescue object, or a mobile phone number of a friend of the rescue object to a mobile phone of the rescue offeror through the communication unit.

7. The unmanned vehicle according to claim 2, wherein,
the broadcasting unit further includes an alarm light that is turned on or flashes during the driving.

8. An unmanned vehicle rescue system, comprising:
a triggering device to send a “help” signal when a rescue object needs to be rescued;
an unmanned vehicle; and
a control center to receive the “help” signal and send the “help” signal to the unmanned vehicle, wherein,
the unmanned vehicle includes:
a communication unit to receive a rescue request signal including personal information and location information of a rescue object;
a main control unit to control the unmanned vehicle to drive to a location of the rescue object; and
a broadcasting unit to broadcast the personal information and location information of the rescue object during driving to the location of the rescue object, wherein,
the main control unit controls the communication unit and the broadcasting unit.

9. The unmanned vehicle rescue system according to claim 8, wherein,
the triggering device includes at least one of a portable electronic device, a physical help button, or a visual help button; and
the portable electronic device includes at least one of a rescue system application (App) or a single-press-to-call-for-help button.

10. The unmanned vehicle rescue system according to claim 8, further comprising:
a terminal receiving device disposed in a rescue office; and
the rescue request signal being sent to the terminal receiving device by the main control unit via the communication unit, or by the control center.

11. The unmanned vehicle rescue system according to claim 8, wherein
the broadcasting unit includes at least one of an audio broadcasting device, or a display device;
the audio broadcasting device is configured to broadcast the personal information and the location information of the rescue object; and
the display device is configured to display the personal information and the location information of the rescue object.

12. The unmanned vehicle rescue system according to claim 11, wherein,
the main control unit is further configured to receive a rescue response signal and obtain information of a rescue offeror;
the rescue response signal is triggered by at least one of:
the rescue offeror pressing an rescue response button disposed on the unmanned vehicle,
the rescue offeror touching a button displayed on the display device, or
the rescue offeror scanning a rescue response QR code displayed on the display device using a mobile electronic device.

13. The unmanned vehicle rescue system according to claim 12, wherein,
the information of the rescue offeror includes location information of the rescue offeror; and
the display device is further configured to display a navigation route from a location of the rescue offeror to the rescue object.

14. The unmanned vehicle rescue system according to claim 12, further comprising:
a photographing device to capture an image of the rescue offeror when the rescue response signal is triggered,
wherein the information of the rescue offeror further includes image information of the rescue offeror.

15. The unmanned vehicle according to claim 12, wherein,
the information of the rescue volunteer includes a mobile phone number of the rescue offeror; and
the main control unit is further configured to send at least one of a mobile phone number of the rescue object, a mobile phone number of a relative of the rescue object, or a mobile phone number of a friend of the rescue object to a mobile phone of the rescue offeror through the communication unit.

16. The unmanned vehicle according to claim 11, wherein,
the broadcasting unit further includes an alarm light that is turned on or flashes during the driving.

17. A method for rescuing, comprising:
receiving, by a communication unit of an unmanned vehicle, a rescue request signal including personal information and location information of a rescue object;
controlling, by a main control unit of the unmanned vehicle, the unmanned vehicle to drive to a location of the rescue object; and
broadcasting, by a broadcasting unit of the unmanned vehicle, the personal information and location information of the rescue object during driving to the location of the rescue object.

18. method according to claim 7, further comprising:
receiving, by the main control unit, a rescue response signal; and
obtaining, by the main control unit, information of a rescue offeror,
wherein the rescue response signal is triggered by at least one of:
the rescue offeror pressing an rescue response button disposed on the unmanned vehicle,
the rescue offeror touching a button displayed on the display device, or
the rescue offeror scanning a rescue response QR code displayed on the display device using a mobile electronic device.

19. The method according to claim 18, further comprising:
capturing, by a photographing device of the unmanned vehicle, an image of the rescue offeror when the rescue response signal is triggered,
wherein the information of the rescue offeror further includes image information of the rescue offeror.

20. The method according to claim 18, wherein,
the information of the rescue volunteer includes a mobile phone number of the rescue offeror; and
the method further comprising sending, by the main control unit, at least one of a mobile phone number of the rescue object, a mobile phone number of a relative of the rescue object, or a mobile phone number of a friend of the rescue object to a mobile phone of the rescue offeror through the communication unit.
